(19) United States
(12) Patent Application Publication
(10) Pub. No.: US 2016/0169480 A1
(43) Pub. Date: Jun. 16, 2016

(54) OPTICAL STRUCTURE FOR A PLURALITY OF LIGHT SOURCES

(71) Applicant: OSRAM GMBH, München (DE)

(72) Inventor: Jing Bao, Shanghai (CN)

(21) Appl. No.: 14/906,290

(22) PCT Filed: Jul. 21, 2014
(86) PCT No.: PCT/EP2014/065653

§ 371 Date: Jan. 20, 2016

(30) Foreign Application Priority Data
Jul. 22, 2013 (CN) 201320437145.9

(51) Int. Cl. F21V 7/04; F21V 7/05; F21V 13/02

(52) U.S. Cl. CPC F21V 7/041; F21V 13/02; F21V 7/05

(57) ABSTRACT

Various embodiments may relate to an optical structure for a plurality of light sources, wherein the optical structure includes a reflective structure and a scattering structure accommodated in the reflective structure, light from the plurality of light sources are at least scattered through the scattering structure to perform primary light mixing so as to produce mixed light beams, wherein the mixed light beams are at least partially reflected by the reflective structure and then emerge.

### RELATED APPLICATIONS

The present application is a national stage entry according to 35 U.S.C. §371 of PCT application No.: PCT/EP2014/065653 filed on Jul. 21, 2014, which claims priority from Chinese application No.: 201320437145.9 filed on Jul. 22, 2013, and is incorporated herein by reference in its entirety.

### TECHNICAL FIELD

Various embodiments relate to an optical structure adapted for a plurality of light sources.

### BACKGROUND

Because of advantages of LED technology such as high efficiency, energy saving, and long service life etc., LED technology is widely used in the field of illumination. In order to produce yellow or white light by means of LED chips of different colors, e.g. blue, red, and green LED chips are usually used, and rays of different colors are mixed to produce white light.

In an existing solution, it is provided that a reflector and a light pipe are used to realize light mixing from rays of different colors. The inner wall of the light pipe includes one or more rippled reflective walls having a plurality of elongated ridges and valleys and sloping surfaces therebetween. Light from an input end propagates along an optical path, is reflected on the sloping surfaces in different directions toward an output end, thereby realizing an effect of mixing rays at the output end. For this method, although it can get good light mixing performance, the length of the whole optical structure is relatively long, the micro reflective surface of the pipe is not easy to design, the achieved optical efficiency is relatively low, and the angle of the produced emergent light cannot be appropriately controlled within a small angle.

### SUMMARY

Various embodiments provide a novel optical structure adapted for a plurality of light sources. Such an optical structure can effectively reduce the length of the structure so as to realize a relatively small structural volume. In addition, such an optical structure further has good light mixing effect and relatively high optical efficiency, so as to mix rays of different colors from the plurality of light sources.

Various embodiments relate to an optical structure adapted for a plurality of light sources, viz. the optical structure includes a reflective structure and a scattering structure accommodated in the reflective structure, light from the plurality of light sources are scattered through the scattering structure to perform at least primary light mixing so as to produce mixed light beams, wherein the mixed light beams are at least partially reflected by the reflective structure and then emerge. In this case, a primary premixing of all the rays from the plurality of light sources is realized by means of the scattering structure, such that rays from the light sources are firstly mixed before reflection through the reflective structure, and then other potential light mixing processes can be realized through the reflective structure.

In various embodiments, the scattering structure is a volume scattering structure embedded with a plurality of scattering particles. E.g. optical plastics and scattering particles can be made into an entity, such that scattering particles are filled in the entity; in this case, it is assured that rays from the light sources are subjected to scattering and light mixing processes inside the entity of the scattering structure.

In various embodiments, the scattering structure is a scattering structure on the surface of which is provided with a scattering layer. Rays from the light sources can be scattered on the surface of the scattering structure by coating the surface of the scattering structure with the scattering layer, and accordingly, rays can then be reflected by the reflective structure to an emergent opening of the reflective structure or incident again into the scattering structure, so as to realize a final light mixing effect.

In various embodiments, the scattering structure includes a bottom surface and a surface rising from the bottom surface, the bottom surface includes a recessed region, the surface of the recessed region forms an incident surface, and rays from the light sources firstly enter through the incident surface, and then at least emerge through the surface of the scattering structure or enter the scattering structure. According to such a design, the light sources can be accommodated in the scattering structure, rays from the light sources are incident into the scattering structure by means of the incident surface, and it can be assured that all the rays from the light sources have to be firstly scattered and mixed through the scattering structure, and then emergent to the reflective structure.

In various embodiments, the light sources are accommodated in the recessed region. By means of the recessed region, the plurality of light sources can be received and fixed in said region, and the surface of the recessed region is deemed as an incident surface, which enables rays from all the light sources to smoothly enter the scattering structure.

In various embodiments, the reflective structure includes a reflective surface, a first opening is defined at an end of the reflective surface, the scattering structure is provided in a room defined by the reflective surface.

In various embodiments, a closed end is formed at the other end of the reflective surface and the scattering structure is provided between the closed end and the first opening. The integral arrangement of the scattering structure in the reflective structure enables that all the rays emergent after scattering through the scattering structure can be collected by the reflective structure, and then reflected by the reflective structure to the scattering structure or directly emerge through the first opening.

In various embodiments, a second opening is formed at the other end, and size of the second opening is smaller than the first opening. An external device, electrical device for example, could be mechanically or electrically connected to the light source through the second opening.

In various embodiments, the bottom surface of the scattering structure is arranged on the side of the reflective structure which is close to the closed end. Through such a design, rays of the light sources, as a whole, emerge from the closed end of the reflective structure towards the first opening, and it is assured that rays scattered by the scattering structure and rays reflected by the reflective structure can both emerge in a substantially same direction, so as to realize the possibility of a high optical efficiency.

In various embodiments, the reflective surface is configured as a smooth curved surface. Such a design is easy to process and manufacture so as to achieve the object of low manufacturing costs while assuring good optical properties.

In various embodiments, the surface includes a top surface and a side surface connecting the bottom surface with the top surface, and the top surface is configured as a smooth curved surface or a flat plane. Through a top surface designed in different manners, rays emergent through the scattering structure may have different light distributions, and light mixing having different effects can be achieved in cooperation with the reflective structure.

In various embodiments, that the scattering structure is configured to be in a shape of any one of cylinder, truncated cone, waist drum shape, and anamorphic shape. According to such a design, not only the scattering structure is enabled to occupy a different volume, rays emergent through the scattering structure can also have different light distributions, and light mixing having different effects can be achieved in cooperation with the reflective structure.

In various embodiments, the reflective structure is configured to have a conical profile. Such a profile provides the effect of effectively collecting scattered light from the scattering structure, while enabling reflected light to emerge overall towards the first opening.

In various embodiments, the reflective structure is configured as a reflective plate with a smooth surface which is made of metal. In this case, not only the design and manufacture process can be simplified, but also a good reflection effect can be achieved.

In various embodiments, a reflective coating is provided on the surface of the reflective structure. Light from the scattering structure could be reflected in high efficiency with the aid of the reflective coating, and a proper optical effect is achieved.

In various embodiments, the reflective structure includes a plurality of reflective subfaces, and light from the light sources s reflected by the plurality of reflective subfaces and exit after being scattered by the scattering structure. In this case, the possibility of reflecting incident light along different directions or the same direction can be realized by means of the plurality of facet reflective surfaces, so as to achieve a relatively precise light mixing effect.

In various embodiments, the optical structure is configured to be rotationally symmetric. It enables light beams emergent through the optical structure to have a rotationally symmetric light distribution.

In various embodiment, viewed from a cross-section perpendicular to the bottom surface and passing the optical axis of the optical structure, the recessed region has a profile of any one of semicircle, cone-shape, and ellipse, The recessed region having a different profile receives the light sources, which enables light from the plurality of light sources to enter the scattering structure with a relatively high efficiency, so as to assure the whole optical efficiency of the optical structure.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a sectional view of an optical structure according to a first example of the present invention;

FIG. 2 is a schematic diagram of the optical path of the optical structure according to the first example of the present invention;

FIG. 3 is a sectional view of an optical structure according to a second example of the present invention; and

FIG. 4 is a schematic diagram of the optical path of the optical structure according to the second example of the present invention.

### DETAILED DESCRIPTION

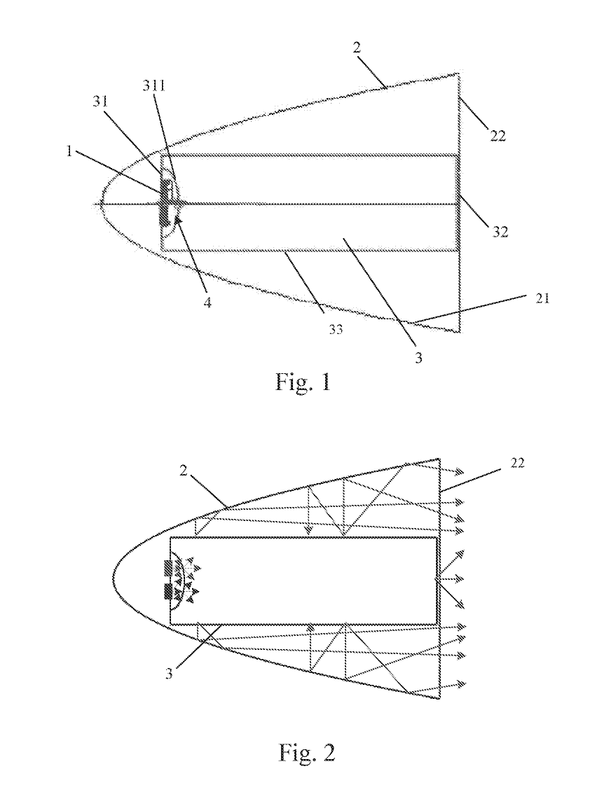

FIG. 1 is a sectional view of the optical structure 100 according to a first embodiment of the present disclosure. The optical structure 100 according to the first embodiment of the present disclosure is shown in FIG. 1, the optical structure 100 includes a reflective structure 2 which is designed to be of e.g. a conical shape or a tulip shape, and a scattering structure 3 which is arranged in the reflective structure 2 and configured as a cylinder. As a whole, the optical structure 100 can be configured to be rotationally symmetric, which can assure that light emergent through said optical structure 100 has a rotationally symmetric light distribution. The reflective structure 2 and the scattering structure 3 can both be configured to be rotationally symmetric, so as to realize that scattered light emergent through the scattering structure 3 is rotationally symmetric in e.g. a circumferential direction, and light reflected by the reflective structure 2 is also rotationally symmetric.

A recessed region 4 is provided on a bottom surface 31 of the scattering structure 3, and such a recessed region 4 can be configured to have a semicircular, semi-oval or a conical profile, in which a light source 1 can be accommodated in a relatively small space, such that all rays from the light source 1 can enter the scattering structure 3 through a surface of the recessed region 4. A plurality of light sources 1 is provided, and the LED of each light source 1 may have different colors, viz. red LEDs, green LEDs, and blue LEDs may be comprised, and rays of different colors can simultaneously enter the scattering structure 3 through an incident surface 311 of the recessed region 4 according to the plurality of LED chips having different colors. Of course, the plurality of light sources 1 may also include LED chips having the same color according to the requirements of actual situations.

The reflective structure 2 is configured to be rotationally symmetric, and the reflective structure 2 has a reflective surface 21 provided as an internal surface, wherein the reflective surface 21 can be configured as e.g. a simple smooth curved surface, and moreover, may be configured to have e.g. a plurality of reflective subfaces that could be arranged in array in inner surface of the reflective structure 2. According to such a design, light beams emergent through the scattering structure 3 can have good reflection characteristics after reflection through the reflective surface 21, and good light mixing effect can be achieved through a relatively precise reflection angle as potentially required with the aid of a plurality of reflective subfaces. The surface of the reflective structure 2 is formed as a closed end at one end, while forming at the other end a first opening 22, which serves as an exit end for rays in the optical structure 100. In addition, the internal surface of the reflective structure 2 forms the reflective surface, which receives all emergent rays from the scattering structure 3 and in the end reflects the rays towards the scattering structure 3 or towards the first opening 22 of the reflective structure 2 for exit. In an unshown embodiment, the closed end of the reflective structure 2 may also be configured to have an opening, and the area of the opening is greater than the area of a circuit board carrying the light sources 1, and according to such a design, the light sources 1 provided in the scattering structure 3 can be in electrical connection with an external power source or a drive circuit directly through the opening, such that the optical structure overall has a relatively small volume because no additional circuit has to be received.

FIG. 2 is a schematic diagram of the optical path of the optical structure according to the first embodiment of the present disclosure. As shown in FIG. 2, rays from the light sources 1 completely enter the scattering structure 3 through the internal surface of the recessed region 4. And according to different arrangements of the scattering structure 3, light mixing can be performed in different manners. E.g. optical plastics are mixed with scattering particles of different sizes and manufactured into an integrative entity structure, and accordingly, rays entering the scattering structure 3 are scattered inside the scattering structure 3, and a primary light mixing effect is realized. As a result, partial rays emergent through the surface of the scattering structure 3 will emerge through the reflective surface of the reflective structure 2, and the partial rays will partially be directly reflected by the reflective structure 2 and then emerge through the first opening 22, while the rest rays will be reflected and enter the scattering structure 3 again, hereby realizing a secondary or similar multiple light mixing processes, and finally emerge through the first opening 22; the residual rays entering the scattering structure 3 from the light sources 1 will directly emerge through another surface of the scattering structure 3, e.g. the top surface 32 arranged opposite to the incident surface 311, after the primary light mixing through the scattering structure 3, and then exit through the first opening 22. A light distribution formed after the final light mixing is formed based on the emergent light mentioned above, so as to form a mixed light of e.g. yellow or white light.

However, it shall be declared that the scattering structure 3 can not only be configured as the entity structure as described above, but also be configured as a scattering coating coated on the surface thereof; in this case, rays from the light sources 1 can be scattered on the surface of the scattering structure 3, and partial rays will emerge through the first opening 22 of the reflective structure 2 after reflection through the reflective structure 2, while the residual rays will be directed to the surface of the scattering structure 3 which has a scattering coating, and then be scattered again, and in this case, repeated scattering and light mixing processes are realized, so as to form the effect of mixed light at the first opening 22.

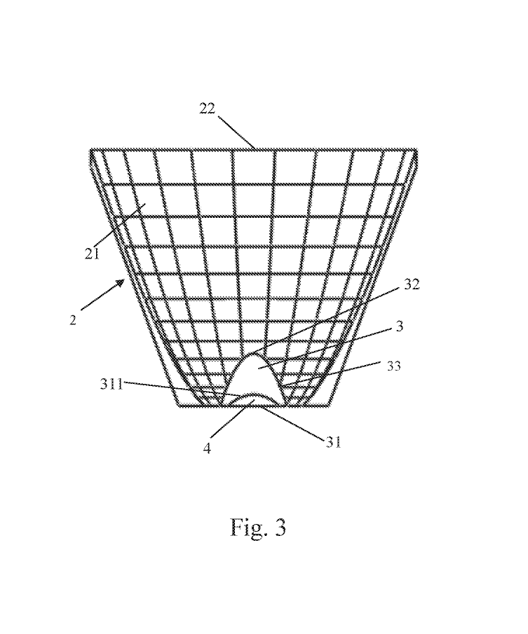

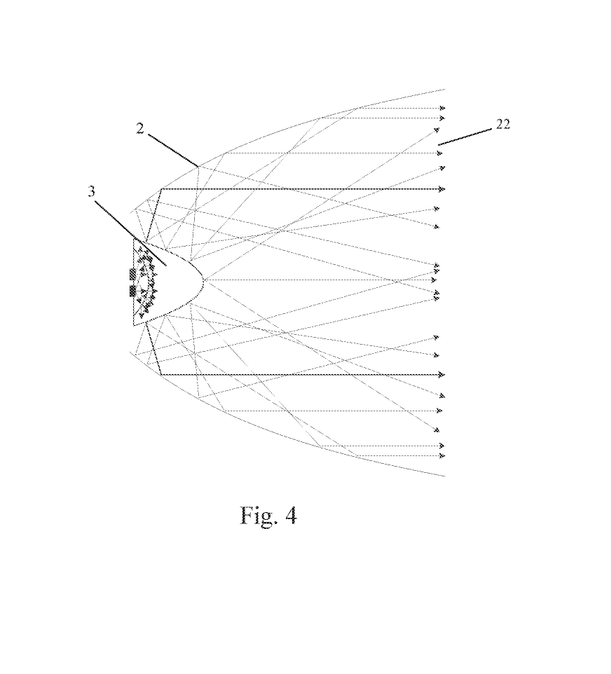

FIG. 3 is a sectional view of the optical structure 100 according to a second embodiment of the present disclosure. As shown in FIG. 3, the optical structure 100 includes a reflective structure 2 configured to be in the shape of e.g. a truncated cone, and a scattering structure 3 configured to be in e.g. a conical shape, which is similar to the first embodiment. The difference with respect to the first embodiment lies in that the scattering structure 3 configured in a conical shape has a top surface, which is configured as a curved surface, instead of a flat top surface of e.g. a cylinder. With reference to FIG. 4, FIG. 4 is a schematic diagram of the optical path of the optical structure 100 according to the second embodiment of the present disclosure, and according to such a design, rays from the light sources 1 are incident through the recessed region 4 of the scattering structure 3, and are subjected to a primary scattering and light mixing process inside the scattering structure 3 through scattering particles filled therein, then exit through the surface of the scattering structure 3, and enter in a direction towards the internal surface of the reflective structure 2, and then directly exit towards the first opening 22 of the reflective structure 2 after reflection through the reflective structure 2, so as to finally form mixed emergent light. Similar to the scattering structure 3 of the first embodiment, the scattering structure 3 according to the second embodiment can not only be configured as an entity filled with scattering particles, but also be configured as a scattering structure 3 with a scattering coating coated on the surface thereof.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An optical structure adapted for a plurality of light sources, comprising:
a reflective structure and a scattering structure accommodated in the reflective structure, wherein rays from the plurality of light sources are scattered through the scattering structure to perform at least primary light mixing so as to produce mixed light beams, wherein the mixed light beams are at least partially reflected by the reflective structure and then emerge.

2. The optical structure according to claim 1, wherein the scattering structure is a solid scattering structure embedded with a plurality of scattering particles.

3. The optical structure according to claim 1, characterized in that wherein the scattering structure is a scattering structure on the surface of which a scattering layer is provided.

4. The optical structure according to claim 1, wherein the scattering structure comprises a bottom surface and a surface rising from the bottom surface, the bottom surface comprises a recessed region, the surface of the recessed region forms an incident surface, and rays from the light sources enter through the incident surface, and then at least emerge through the surface of the scattering structure or enter the scattering structure.

5. The optical structure according to claim 4, wherein the light sources are accommodated in the recessed region.

6. The optical structure according to claim 1, wherein the reflective structure comprises a reflective surface, a first opening is defined at an end of the reflective surface, the scattering structure is provided in a room defined by the reflective surface.

7. The optical structure according to claim 6, wherein a closed end is formed at the other end, and the scattering structure is provided between the closed end and the first opening.

8. The optical structure according to claim 6, wherein a second opening is formed at the other end, and size of the second opening is smaller than the first opening.

9. The optical structure according to claim 7, wherein the bottom surface of the scattering structure is arranged on the side of the reflective structure which is close to the closed end.

10. The optical structure according to claim 6, wherein the reflective surface is configured as a smooth curved surface.

11. The optical structure according to claim 3, wherein the surface comprises a top surface and a side surface connecting the bottom surface with the top surface, and the top surface is configured as a smooth curved surface or a flat plane.

12. The optical structure according to claim 1, wherein the scattering structure is configured to be in a shape of any one of cylinder, truncated cone, waist drum shape, cone, and anamorphic shape.

13. The optical structure according to claim 1, wherein the reflective structure is configured to have a conical profile.

14. The optical structure according to claim 1, wherein the reflective structure is configured as a reflective plate with a smooth surface which is made of metal.

15. The optical structure according to claim 1, wherein a reflective coating is provided on the surface of the reflective structure.

16. The optical structure according to claim 1, wherein the reflective structure comprises a plurality of reflective subfaces, and light from the light sources is reflected by the plurality of reflective subfaces and exit after being scattered by the scattering structure.

17. The optical structure according to claim 1, wherein the optical structure is configured to be rotationally symmetric.

18. The optical structure according to claim 1, wherein viewed from a cross-section which is perpendicular to a bottom surface and through which the optical axis of the optical structure passes, the recessed region has a profile of any one of semicircle, cone-shape, and ellipse.
